(19) United States
(12) Patent Application Publication
(10) Pub. No.: US 2009/0081118 A1
(43) Pub. Date: Mar. 26, 2009

(54) Unknown

(76) Inventors: Dirk Gerhard, Mannheim (DE); Peter Wasserscheid, Erlangen (DE); Daniel Assenbaum, Heideck (DE); Peter Schulz, Erlangen (DE)

Correspondence Address: MILLEN, WHITE, ZELANO & BRANIGAN, P.C., 2200 CLARENDON BLVD., SUITE 1400, ARLINGTON, VA, 22201, US

(21) Appl. No.: 12/222,804

(22) Filed: Aug. 15, 2008

(30) Foreign Application Priority Data
Aug. 17, 2007 (DE) 102007038965.7

(51) Int. Cl. C01B 3/22; C09K 3/00

(52) U.S. Cl. 423/648.1; 252/193

(57) ABSTRACT

A storage medium for storing hydrogen as well as a process for storing hydrogen are described.

According to the invention, the storage medium has an ammonia-borane complex that is present in at least one dehydrogenatable ionic liquid.

In this connections the proportion of the ammonia-borane complex to the ionic liquid is between 0.01 and 500, preferably between 0.2 and 10, and in particular between 0.5 and 20.

The invention relates to a storage medium as well as a process for storing hydrogen.

Since the commercialization of fuel cell technology, hydrogen storage has not presented a major challenge to one skilled in the art. If the user or the consumer is not part of a hydrogen network, such as, for example in the chemical industry, the hydrogen has to be transported from the producer to the consumer. In this case, efficient storage of hydrogen plays an important role.

The current forms of pressure storage and the cryogenic storage of hydrogen are inefficient because of their low gravimetric storage density. Thus, in a commercially available gas bottle with a volume of 50 L and a filling pressure of 300 bar, only 1.36 kg of hydrogen can be transported. Relative to the empty weight of such a compressed gas cylinder of about 90 kg, this corresponds only to a gravimetric storage density of about 1.5% by weight. Moreover, even moderate compression to 200 bar requires just under 15% of the specific energy content of the hydrogen.

Storage as a liquid medium with up to 5% by weight specifically has a higher storage density, but shows considerable drawbacks, such as the high loss rate of up to 1% by weight per day. In addition, the energy requirement for the liquefaction of hydrogen is approximately 28% of the specific energy content. In addition, it is disadvantageous that both above-mentioned storage forms make expensive “packaging” and removal systems necessary, which are ultimately responsible for the high weight of the storage system.

To increase the gravimetric storage density, storage systems are located in the experimental stage in which the storage of the hydrogen is carried out in hydrogenatable organic compounds that are able to bind chemically to the hydrogen. In 2003, Hodoshima et al. reported on a system based on decalin/naphthalene, with which a theoretical gravimetric storage density of up to 8.6% by weight can be achieved. Also known is a storage system that consists of N-ethylcarbazole/N-ethyl-9H-carbazole, from which hydrogen can be released in a reversible manner. A generic storage medium and a process for the storage of hydrogen, which are based on dehydrogenatable ionic compounds, are known from the German Patent Application 102004047986.

In addition, the use of an ammonia-borane complex H₃NBH₃ for storage of hydrogen is examined by various research groups. In this connection, the release of chemically bonded hydrogen can be carried out by thermal or metal- or acid-catalyzed decomposition. The ammonia-borane complex has a theoretical gravimetric storage density of 19.4% by weight. A slow kinetics of the hydrogen production and the formation of borazine as a volatile by-product is disadvantageous, however, specifically in the thermal release from the pure substance. At 85° C., therefore, 1.1 equivalents of hydrogen can be recovered only after about 20 hours; the induction time is 60 minutes in this case.

The object of this invention is to indicate a generic storage medium for hydrogen as well as a generic process for storing hydrogen, which has a large gravimetric storage density and, moreover, makes possible a quick release of the bonded hydrogen. Moreover, an almost complete regeneration of the storage medium is to be possible.

To achieve this object, a storage medium is proposed that is characterized in that it has an ammonia-borane complex that is present in at least one dehydrogenatable ionic liquid.

Additional advantageous embodiments of the storage medium according to the invention as well as the process for hydrogen storage according to the invention, which represent the subjects of the dependent claims, are characterized in that
The proportion of the ammonia-borane complex to the ionic liquid is between 0.01 and 500, preferably between 0.2 and 10, and in particular between 0.5 and 20,
The pressure of the storage medium is between 0.1 and 10 bar, preferably between 0.5 and 5 bar, and in particular between 0.7 and 2 bar,
The storage medium has a catalyst, preferably a metal-containing catalyst,
Whereby the amount of catalyst relative to the ammonia-borane complex is between 0.001 and 10 mol %, preferably between 0.05 and 5 mol %, and in particular between 0.5 and 2.5 mol %,
Gold, silver, palladium, rhodium, ruthenium, iridium, platinum and/or nickel is used as a catalyst material,
The catalyst is attached to a support, whereby preferably carbon, aluminum oxide, titanium oxide, silicon oxide, zeolite and/or other porous materials are used as support materials,
The proportion of catalyst on the support is between 0.1 and 15% by weight, preferably between 0.5 and 10% by weight, and in particular between 1 and 5% by weight, and
To release the stored hydrogen, the storage medium is brought to a temperature of between 20 and 500° C., preferably between 50 and 400° C., and in particular between 80 and 350° C.

According to the invention, a storage system for hydrogen storage is now proposed, in which an ammonia-borane complex is present in a dehydrogenatable ionic liquid. Surprisingly enough, it is possible to release hydrogen from this storage system or medium simultaneously by dehydrogenation of the ionic liquid and decomposition of the ammonia-borane complex.

In this connection, according to the invention, the release of the bonded hydrogen takes place at a temperature of between 20 and 500° C., preferably between 50 and 400° C., and in particular between 80 and 350° C.

By the addition of a suitable ionic liquid and a heterogeneous (noble) metal catalyst to the ammonia-borane complex, the amount of the generated hydrogen and the time necessary for the generation can be influenced in a positive manner.

The storage system or medium according to the invention is distinguished by a storage capacity that is increased in comparison to known storage systems or media as well as by a faster and more uniform release of hydrogen. At the same time, the release of hydrogen takes place under milder conditions and without the formation of the undesirable by-product borazine. Moreover, the storage system or medium according to the invention can be regenerated. Thus, it is then available for a renewed release of hydrogen.

Because of these improved properties, the storage system or medium according to the invention can be used in all technical applications in which cryogenic or liquid storage forms of hydrogen have been produced to date. By way of example, mobile fuel cells can be mentioned, as they are used in so-called hydrogen cars or portable consumers, such as laptops, MP3 players or cell phones. In this case, the efficiency of hydrogen as an energy source is significantly improved by the reduced weight of the overall storage system or medium.

The storage medium according to the invention as well as the process according to the invention for storing hydrogen are explained in more detail below based on an embodiment.

4.87 g (0.01 mol) of 1-methyl-3-[3-(cyclohexyl)propyl]-imidazolium bis(trifluoromethylsulfonyl)imide is introduced into a 60 ml autoclave with a magnetic stirring core and mixed with 4.87 g (0.16 mol) of ammonia-borane complex and 1.67 g of palladium on carbon (5% by weight). A homogeneous suspension is obtained by vigorous stirring at room temperature. The autoclave is flushed several times with argon and then heated at a heating rate of 1 K/minute to 300° C. This temperature is maintained for 3 hours.

The volume of the gas that is liberated is determined with a gas measuring apparatus. The gas composition is examined by means of gas-chromatographic methods. The amount of hydrogen produced can be derived from the volume, the purity of the gas and the ideal gas law. Within 3 hours, 6.2% by weight of pure hydrogen can be generated in this way, relative to the total weight of the mixture that is used.

Without further elaboration, it is believed that one skilled in the art can, using the preceding description, utilize the present invention to its fullest extent The preceding preferred specific embodiments are, therefore, to be construed as merely illustrative, and not limitative of the remainder of the disclosure in any way whatsoever.

In the foregoing and in the examples, all temperatures are set forth uncorrected in degrees Celsius and, all parts and percentages are by weight, unless otherwise indicated The entire disclosures of all applications, patents and publications, cited herein and of corresponding German Application No. 102007038965.7, filed Aug. 17, 2007 are incorporated by reference herein.

From the foregoing description, one skilled in the art can easily ascertain the essential characteristics of this invention and, without departing from the spirit and scope thereof, can make various changes and modifications of the invention to adapt it to various usages and conditions.

1. A storage medium for storing hydrogen, having an ammonia-borane complex that is present in at least one dehydrogenatable ionic liquid having as an anion bis (trifluoromethyl sulfonyl) imide.

2. A storage medium according to claim 1, wherein the proportion of ammonia-borane complex to ionic liquid is between 0.01 and 500.

3. A storage medium according to claim 1, wherein the pressure of the storage medium is between 0.1 and 10 bar.

4. A storage medium according to claim 1, wherein the storage medium has a metal-containing catalyst.

5. A storage medium according to claim 4, wherein the amount of catalyst relative to the ammonia-borane complex is between 0.001 and 10 mol %.

6. A storage medium according to claim 4, wherein the metal-containing catalyst comprises at least one of gold, silver, palladium, rhodium, ruthenium, iridium, platinum and/or nickel.

7. A storage medium according to claim 6, wherein the catalyst is attached to a support, comprising carbon, aluminum oxide, titanium oxide, silicon oxide, zeolite and/or other porous materials.

8. A storage medium according to claim 7, wherein the proportion of catalyst on the support is between 0.1 and 15% by weight.

9. A process for storing hydrogen, wherein the hydrogen is stored by means of a storage medium according to claim 1.

10. A process according to claim 9, wherein to release the stored hydrogen, the storage medium is brought to a temperature of between 20 and 500.

11. A storage medium according to claim 1, wherein the ionic liquid comprises as a cation 1-methyl-3-[3-cyclohexyl) propyl-imidazolium.
